(19) United States
(12) Patent Application Publication
(10) Pub. No.: US 2021/0060886 A1
(43) Pub. Date: Mar. 4, 2021

(54) Co-Cured Multi-Piece Tubular Composite Body

(71) Applicant: Bell Textron Inc., Fort Worth, TX (US)

(72) Inventors: Nicholas Allen Torske, Lewisville, TX (US); Steven Cordell, Covington, TX (US); James Cordell, Azle, TX (US); Michael Christopher Burnett, Fort Worth, TX (US); Mark Mays, Bedford, TX (US)

(73) Assignee: Bell Textron Inc., Fort Worth, TX (US)

(21) Appl. No.: 16/555,108

(22) Filed: Aug. 29, 2019

(51) Int. Cl. B29D 99/00; B64F 5/10

(52) U.S. Cl. CPC B29D 99/0028; B29K 2307/04; B64F 5/10

(57) ABSTRACT

Embodiments are directed to systems and methods for manufacturing composite assemblies comprising laying up composite plies on molds for two or more uncured components, joining the molds for the two or more uncured components to form a tubular body, and curing the joined components simultaneously to create a single composite assembly. The single composite assembly may form a spar for an aerodynamic component. The method may further comprise forming at least one axial edge having a sloped shape on the uncured components and mating the sloped axial edges together when joining the uncured components. The molds for the two or more uncured components may comprise female tools or both female tools and male tools. The two or more cured composite assemblies may comprise one or more of carbon and fiberglass composite materials.

### BACKGROUND

Composite assemblies are created by laying up an assembly of uncured details and material. This typically consists of laying dry fabric layers (“plies”) by hand to create a laminate stack. Resin is then applied to the dry plies after layup is complete. Alternatively, “wet” composite plies that have resin built in may be used in the layup. Composite fabrication usually involves some form of mold tool to shape the plies and resin. A mold tool is required to give the unformed resin/fiber combination its shape prior to and during cure. Once the layup is complete, the composite is cured. The cure can be accelerated by applying heat and pressure to the composite layup.

A composite assembly may be used as a structural member for an aircraft component, for example. These structural members are often referred to as a “spar,” and they may extend the axial length of a structure to provide support against loads applied on the structure. In the case of an aerodynamic component, such as propellers, rotor blades, and wings, for example, the spar may support both the weight of the aerodynamic component and any aerodynamic loads applied to the aerodynamic component, such as lift and drag forces. The spar is the primary structural member or backbone of many aircraft components. Due to the tubular geometry of typical spars, it can be challenging to produce a spar that fully forms to the desired shape without wrinkles or other defects that arise due to the inherent trapping condition exhibited by non-symmetric shapes and woven composite materials.

In existing manufacturing processes, a spar may be formed using a composite preform that is cured prior to assembly with the other components of the structure, such as skin assemblies in the case of composite blades. During this curing process, an inflatable bladder may be disposed within the uncured spar and expanded to help compact the layers of preformed composite material and remove any excess air bubbles or other voids included in the preform as the spar is cured at an elevated temperature within a precision mold. Once cured, the other components or details of the composite assembly are assembled with the spar. For instance, in the case of a rotor blade, outer skins and a leading edge are assembled with the spar and then bonded in a subsequent curing process.

The process of laying up a spar as one single structure requires a lot of manipulation which can lead to defects during the manufacturing process. For example, when the plies in the layers are oriented at various angles, such as off-axis plies that overlie unidirectional, full-span plies, the difference can cause wrinkling and bunching of the layers during cure.

### SUMMARY

Embodiments are directed to systems and methods for manufacturing composite assemblies comprising laying up composite plies on molds for two or more uncured components, joining the molds for the two or more uncured components to form a tubular body, and curing the joined components simultaneously to create a single composite assembly. The single composite assembly may form a spar for an aerodynamic component. The method may further comprise forming at least one axial edge having a sloped shape on the uncured components and mating the sloped axial edges together when joining the uncured components. The molds for the two or more uncured components may comprise female tools or both female tools and male tools. The two or more cured composite assemblies may comprise one or more of carbon and fiberglass composite materials.

After curing, at least two components may be attached together using fasteners, such as metal or composite clips. After curing the joined components, one or more additional composite plies may be applied over a seam between two components, and the additional composite plies may be cured to bond the additional composite plies to the single composite assembly.

One or more additional composite plies may be wrapped around the single composite assembly, and the additional composite plies may be cured to bond the additional composite plies to the single composite assembly.

Additional embodiments are directed to systems and methods manufacturing composite assemblies comprising laying up composite plies on molds for two or more uncured outer components, laying up composite plies on a mandrel for one or more uncured inner components, joining the molds for the two or more uncured outer components to form a tubular body that surrounds the mandrel, and curing the two or more uncured outer components and the one or more uncured inner components simultaneously to create a single composite assembly.

The composite plies on the mandrel may form a single uncured inner component that wraps around the circumference of the mandrel. The composite plies on the mandrel may also form two or more uncured inner component that each wrap partially around the circumference of the mandrel. Alternatively, the composite plies on the mandrel may form a single uncured inner component that wraps partially around the circumference of the mandrel.

After curing the components to create the single composite assembly, one or more additional composite plies may be applied over a seam between two outer components, and the additional composite plies may be cured to bond the additional composite plies to the single composite assembly.

One or more additional composite plies may be wrapped around the single composite assembly, and the additional composite plies may be cured to bond the additional composite plies to the single composite assembly.

In another embodiment, a device, comprises two or more outer composite assemblies that are separately laid up in different tools and then cured together to form a tubular composite structure. The device may further comprise an inner composite assembly configured to fit between the outer composite assemblies and cured together with the outer assemblies to form the tubular composite structure. The device may further comprise one or more fasteners configured to reinforce an attachment between two outer composite assemblies.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example aircraft that can be used with certain embodiments of the disclosure.

FIG. 2 is a perspective view of an exploded uncured composite assembly for use in one embodiment.

FIG. 3A illustrates two halves of a generally symmetrical tubular composite part.

FIG. 3B illustrates a final tubular part once the halves shown in FIG. 3A have been bonded together.

FIG. 4A illustrates multiple component assemblies of an asymmetrical tubular composite part.

FIG. 4B illustrates a final tubular part once the component assemblies shown in FIG. 4A have been bonded together.

FIG. 5 depicts an alternative composite structure comprising two halves and an inner core.

FIG. 6 is a cross-section view of a composite body comprising outer components and a single inner core component.

FIG. 7 is a cross-section view of a composite body comprising outer components and multiple separate inner components.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

Embodiments are directed toward providing a high-quality composite part using a process that lowers the risk of manufacturing defects and reduces the manufacturing time. A tubular composite assembly may be laid up in pieces that are later combined, which provides both quality improvements and potential manufacture time reductions. This provides overall cost savings and allows for faster production rates.

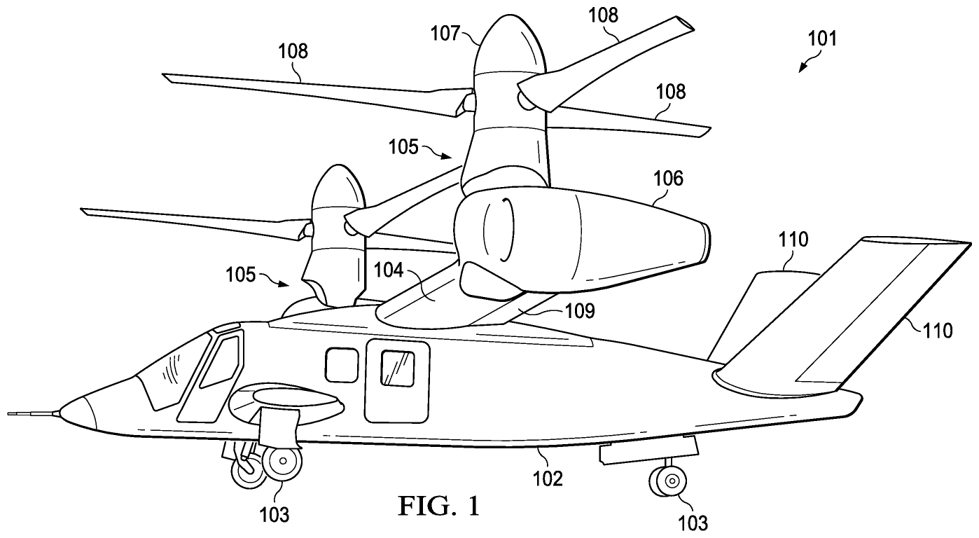

FIG. 1. illustrates an aircraft 101. Certain embodiments of the disclosure may be used with an aircraft, such as aircraft 101. However, aircraft 101 is used merely for illustration purposes. It will be understood that composite materials manufactured using the embodiments disclosed herein may be used with any aircraft, including fixed wing, rotorcraft, commercial, military, or civilian aircraft, or any other non-aircraft structure requiring a hollow or tubular construction. Embodiments of the present disclosure are not limited to any particular setting or application, and embodiments can be used with a rotor system in any setting or application such as with other aircraft, vehicles, or equipment. Certain embodiments of the composite assemblies and methods of forming such disclosed herein may be used for any application involving a composite, aerodynamically shaped object. For example, some embodiments of the composite assemblies disclosed herein may be used for the rotors, propellers, wings, or control surfaces of an aircraft.

Aircraft 101 may include fuselage 102, landing gear 103, and wings 104. A propulsion system 105 is positioned on the ends of wings 104. Each propulsion system 105 includes an engine 106 and a proprotor 107 with a plurality of rotor blades 108. Engine 106 rotates proprotor 107 and blades 108. Proprotor 107 may include a control system for selectively controlling the pitch of each blade 108 to control the direction, thrust, and lift of aircraft 101. Although FIG. 1 shows aircraft 101 in a helicopter mode wherein proprotors 107 are positioned substantially vertical to provide a lifting thrust. It will be understood that in other embodiments, aircraft 101 may operate in an airplane mode wherein proprotors 107 are positioned substantially horizontal to provide a forward thrust. Proprotors 107 may also move between the vertical and horizontal positions during flight as aircraft 101 transitions between a helicopter mode and an airplane mode. Wings 104 may provide lift to aircraft 101 in certain flight modes (e.g., during forward flight) in addition to supporting propulsion systems 105. Control surfaces 109 on wing 104 and/or control surfaces 110 are used to adjust the attitude of aircraft 101 around the pitch, roll, and yaw axes while in airplane mode. Control surfaces 109 and 110 may be, for example, ailerons, flaps, slats, spoilers, elevators, or rudders. Wings 104, rotor blades 108, and/or control surfaces 109, 110 may be composite assemblies each comprising a spar and a set of upper and lower skins that extend along the spar. In some embodiments, the composite assemblies may have an upper core, a lower core, and a septum support layer extending between the upper and lower cores.

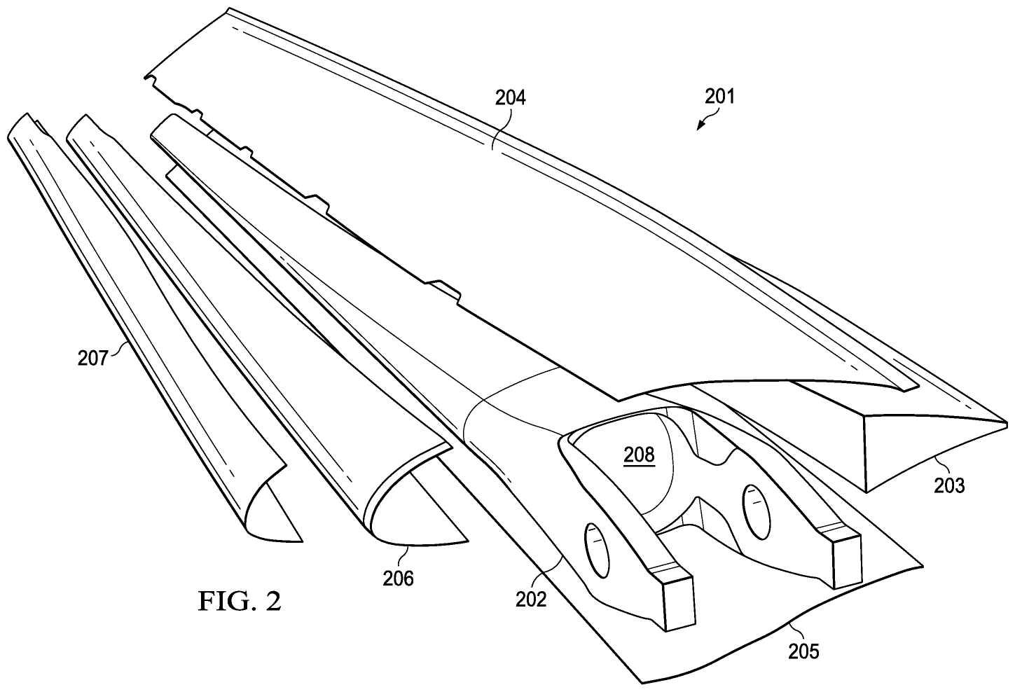

FIG. 2 is a perspective view of an exploded composite assembly 201. In one embodiment, assembly 201 may be used to form the main rotor blades 108 of aircraft 101, for example. In another embodiment, assembly 201 may be used to form the wings 104 and/or control surfaces 109, 110 of aircraft 101. Composite assembly 201 generally comprises a plurality of details, such as a spar 202, a trailing-edge core 203, an upper skin 204, a lower skin 205, a leading-edge sheath 206, and an abrasion strip 207. The core and skin structures may be bonded or otherwise attached to the spar 202 to create a desired airfoil profile. For example, the blade components may be bonded together using layers of adhesive between each interface to form the final assembly 201.

Spar 202 itself may be a composite assembly, such as fabric layers or plies that are laid by hand to form a laminate stack and then cured using a resin that is applied to the dry plies after layup is complete. Spar 202 may have a central cavity 208 to create a hollow structure to reduce weight. Spar 201 may comprise two or more layers of uncured unidirectional laminate material. The plurality of unidirectional layers may be stacked or layered at varying angular directions relative to one another to achieve the desired strength and flexibility desired for the particular application. Each unidirectional layer is formed from fiberglass or carbon fiber composite material. However, in other embodiments the unidirectional layers may comprise other types of composite materials. In existing assemblies, spar 201 is manufactured as a single unit.

In embodiments of the disclosure, the design and manufacture of tubular composite bodies, such as spar 201, may be broken into two or more parts in order to simplify the manufacturing process and to minimize defects. The tubular composite bodies may be any symmetric and nonsymmetric tubular shape or composite body of revolution in which the full circumference design is divided into multiple pieces. When manufactured as a single composite tubular component having plies that are oriented at different angles in different layers, the difference in ply orientation can cause wrinkling and bunching (i.e., “finger-trapping effect”) of the layers during cure.

In one embodiment, a multi-piece assembly for a complex composite tubular assembly or body of revolution is constructed of multiple individually laid up details or parts that are mated together and cured simultaneously to form one final part. The details may be brought together with a scarf joint or butt splice. The design may also include an inner or outer composite clip or tube to tie the multiple pieces together and to increase structural capability. The construction process proposed herein will greatly improve the manufacturability of major composite assemblies. The process simplifies the required tooling family by eliminating the need for a layup mandrel and improves product quality by allowing laying up directly on the final outer mold line surface. The ability to lay up each individual detail simultaneously also reduces manufacturing time.

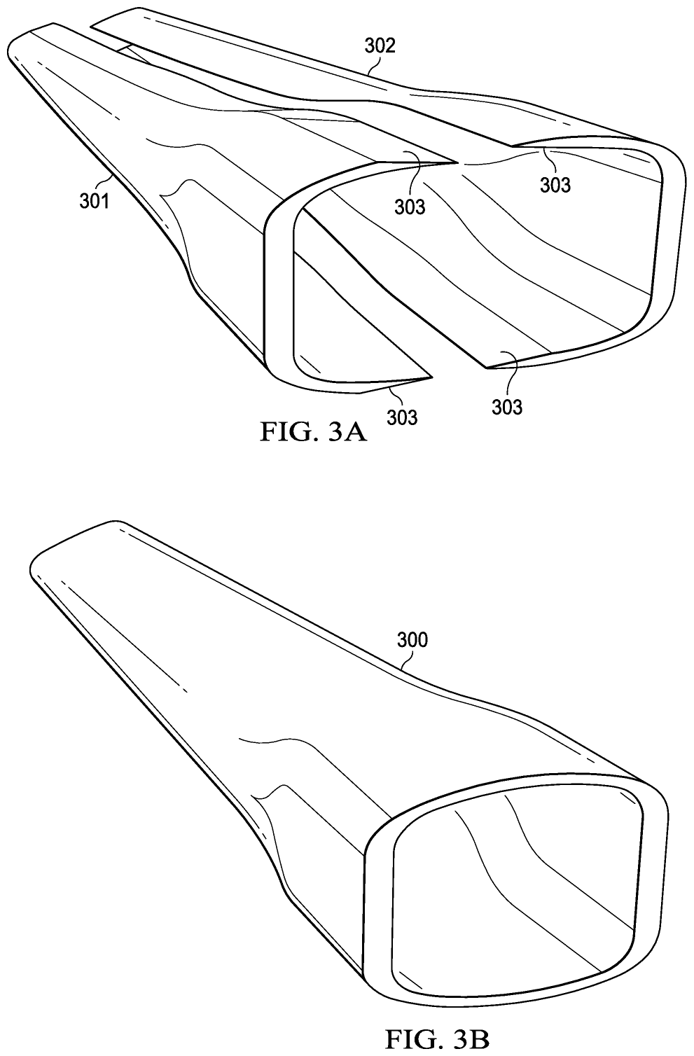

FIG. 3A illustrates two halves 301, 302 of a generally symmetrical tubular composite part. Each half 301, 302 may be laid up directly into separate female molds. This allows the material to be laid up directly on the bond surface in the female mold. FIG. 3B illustrates the final tubular part 300 wherein the two halves 301, 302 have been brought together and co-cured. The two halves 301, 302 may be brought together by joining two separate female bond molds, for example. The details 301, 302 of the final tubular composite part 300 are laid up separately but cured together to increase the strength of the final part. The bond between the individual parts 301, 302 is strengthened by allowing the fibers and resin from both parts to mix together while curing.

An advantage to manufacturing part 300 in this way is a significant span time improvement versus the traditional method of laying up all of the material on a single tool that has to then be transferred to another tool. Using the method disclosed herein, each half 301, 302 of the component 300 is laid up at the same time, which cuts the span time for the layup essentially in half by doing both sides simultaneously.

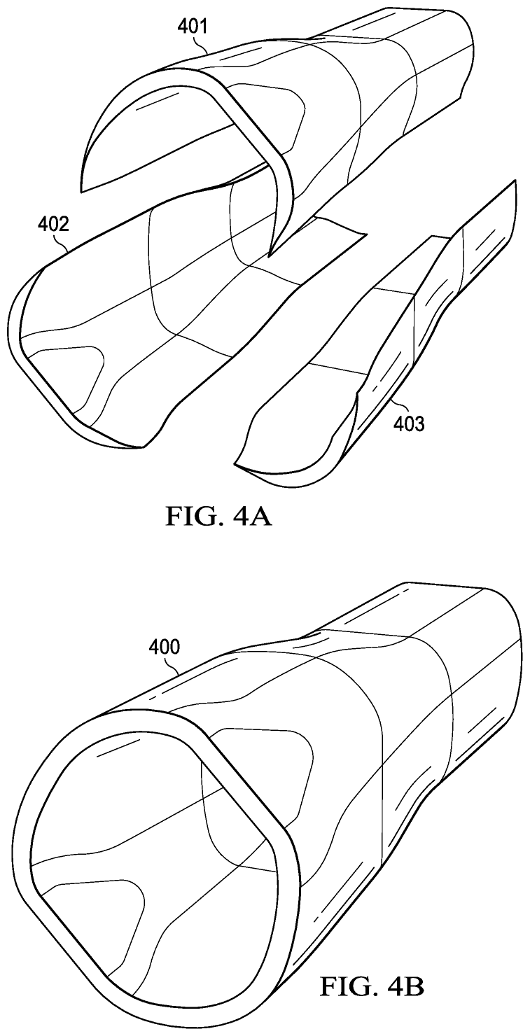

The final tubular part may be divided into any number of pieces. FIG. 4A illustrates three components 401, 402, 403 of an asymmetric tubular composite part. Each component 401-403 is laid up separately on a different tool. FIG. 4B illustrates the final tubular part 400 once the parts 401, 402, 403 have been brought together and then co-cured. The shape and number of the component parts 401, 402, 403 are tailored depending upon the complexity of the geometry of the final part 400 and the requirements of each individual component part 401, 402, 403. The component parts may be constructed to enhance or otherwise support bonding together. The edges of component parts 401-403 may have a shallow angle or draft that increases the overlapping area between the parts in order to maximize the bonding surface area. The joined edges are generally referred to herein as axial edges because they are oriented parallel to the axis of the spar. Depending upon the number of subparts and the precured details, the seams or bond lines could be located anywhere around the circumference of the final composite assembly.

In existing manufacturing processes, the composite material is applied to a male mandrel and then a female mold encases the material. The female mold is then compacted down on the male mandrel very tightly. Either the mandrel or a bladder is used to blow the composite material back out to the female mold. The motion of compacting and then blowing the material back out often causes wrinkles in the structure. An advantage of the process disclosed herein is that the material can be compacted directly to the female molds and so there is no need to blow the material out against the mold. This process allows the manufacturer to compact material directly to the mold surface in a calm state and in the desired final configuration. This results in less material movement.

The individual pieces are connected using a scarf or butt joint, for example. The interface between the component parts may be dependent upon the mold design and/or how the material is laid up into the mold. The overlap between the components may also be dependent upon the structure of the composite materials and required surface area contact for a sufficient bond. Individual plies are laid up on one mold and then on the opposite (FIG. 3) or adjacent (FIG. 4) mold. The composite material may be laid up as appropriate for the component design with plies running in different orientations, such as at 0, 90, and/or 45 degrees. The two molds are then brought together so that the layup of the material in the bond tool and interconnection of the molds control how the components are joined.

An additional advantage of laying up separate component parts individually instead of laying up the entire tubular assembly is the ability to select inner or outer molds for each component part. When a tubular composite assembly is created as a single unit, the tool is typically used to form an inner surface on which the plies are laid up. However, when individual composite assembly components are created, each piece of the final tubular assembly can be formed using a tool that shapes either the inner or outer surface of that component. Moreover, one or more composite assembly components may be laid up on an inner mold tool and one or more other composite assembly components may be laid up on an outer mold tool. This allows for optimal tool selection for each component part. Each layer of plies may be formed from fiberglass, carbon fiber, or other composite materials or a combination of two or more materials.

Although the example illustrated in FIGS. 3A/B and 4A/B refer to construction of a spar, it will be understood that the disclosed composite manufacturing process can be used for any other tubular or conical aircraft components, such as a spindle, grip, cuff, and the like.

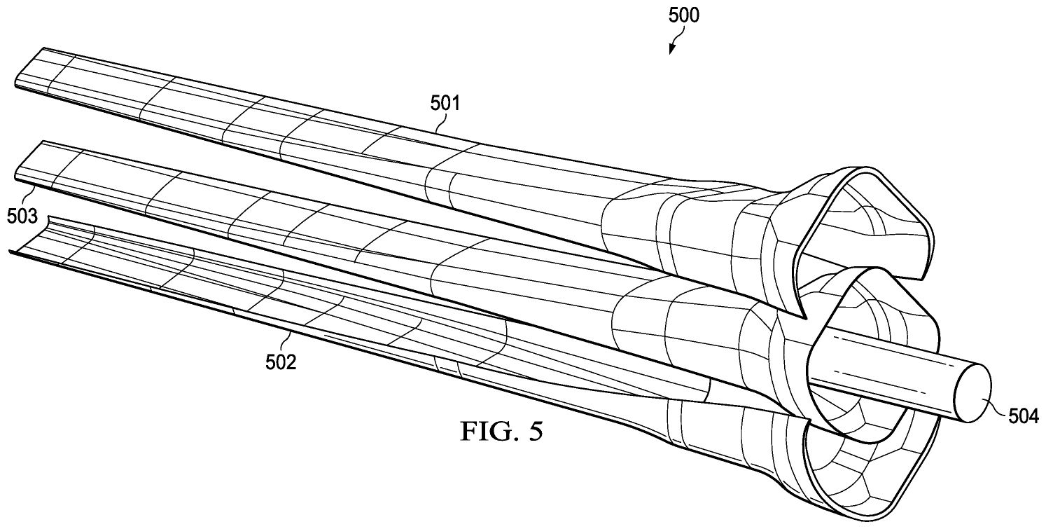

FIG. 5 depicts an alternative composite structure 500 comprising two halves 501, 502 and an inner core 503. In other embodiments, more than two outer components may be used. Similar to components 301, 302 in FIGS. 3A and 3B, the outer halves 501, 502 are separately laid up into female molds (not shown). The material for inner core 503 is laid up on a mandrel or semi-rigid bladder 504. After laying up the material for all three components, the outer molds are joined together around the inner core. The inner material 503 is then blown outward, such as by inflating the bladder 504, to join with the outer halves 501, 502. The entire structure is then cured together to form the final composite body 500. FIG. 5 depicts an inner core 503 having material that is wrapped 360 degrees around semi-rigid bladder 504. It will be understood that, in other embodiments, the inner material may be positioned in narrower regions and may not extend fully around the circumference of bladder 504. For example, the inner material may be positioned to overlap and support the seams between outer halves 501, 502 and/or positioned to add structural support to the final component 500.

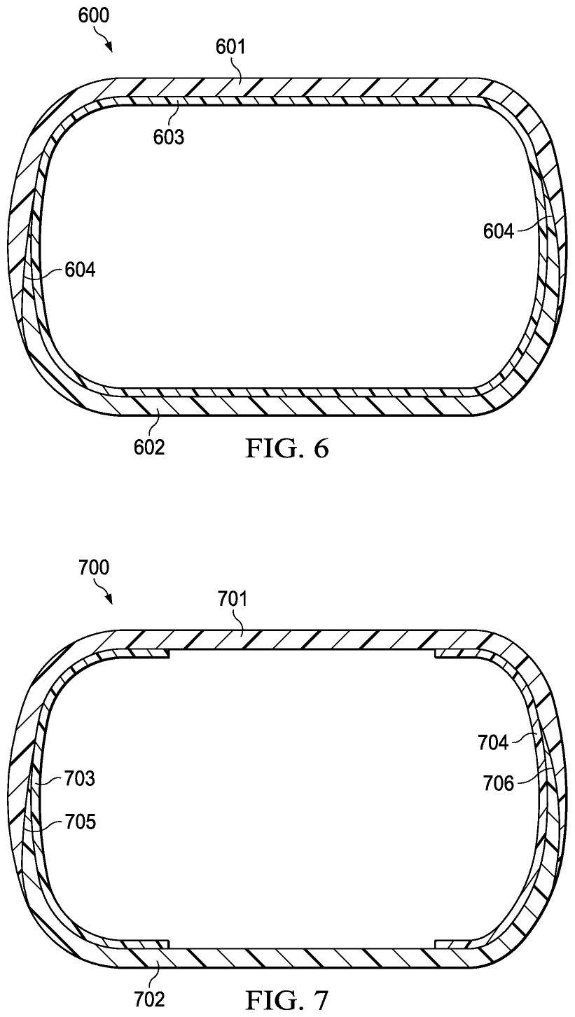

FIG. 6 is a cross-section view of a composite body 600 comprising outer components 601 and 602 and an inner component 603. Outer components 601, 602 are mated together using scarf joints 604. Each component 601-603 is laid up separately and then brought together before curing. Outer components 601, 602 may be laid up in female molds (not shown) while inner component 603 is laid up using a semi-rigid bladder (not shown). When the components are combined, the inner component 603 is blown out against outer components 601, 602 to ensure contact while the composite body 600 is cured. Inner component 603 provides overall structural support for composite body 600 as well as reinforcing joints 604.

FIG. 7 is a cross-section view of a composite body 700 comprising outer components 701 and 702 and inner components 703 and 704. Outer components 701, 702 are mated together using scarf joints 705 and 706. Each component 701-704 is laid up separately and then brought together before curing. Outer components 701, 702 may be laid up in female molds (not shown) while inner components 703 and 704 may be laid up on a semi-rigid bladder (not shown). When the components are combined, the inner components 703, 704 are blown out against outer components 701, 702 to ensure contact while the composite body 700 is cured. Inner components 703 and 704 may provide structural support for composite body 700 and/or may function to specifically reinforce joints 705 and 706. Inner components 703, 704 may function as torque clips or as splice plates, for example.

In other embodiments, instead of both inner components 703, 704, only one inner component may be needed. Additionally, or alternatively, the outer component parts 701, 702 may be bonded together using fasteners, such as composite or metal clips, that are applied before or after curing.

After the initial curing, additional composite plies may be laid over the seams 705, 706 (on the inside and/or outside surface of component 700) and cured again to form a secondary bond to protect or hide the seam and/or to reinforce the bond between component parts. In another embodiment, torque-wrap plies may be laid up around (i.e., outer wrap) and/or laid up inside (i.e., inner wrap) the final assembly of the component parts. The torque-wrap plies may be cured after the final assembly of the component parts.

In various embodiments, the plies used to create each of the composite assembly components may be laid up over a male tool and/or laid up inside a female tool. Alternatively, different composite assembly components for the same final tubular assembly may be laid up using both male and female tools. The selection of a tool for a composite assembly component is not available for existing tubular composite parts, which are typically laid up surrounding a male tool. The use of different mold tools in embodiments disclosed herein allows for optimized manufacturing of each composite assembly component.

In an example embodiment, a method of manufacturing composite assemblies comprises laying up composite plies on molds for two or more uncured components, joining the molds for the two or more uncured components to form a tubular body, and curing the joined components simultaneously to create a single composite assembly. The method may further comprise forming at least one axial edge having a sloped shape on the uncured components, and mating the sloped axial edges together when joining the uncured components. The single composite assembly may form a spar for an aerodynamic component. The two or more cured composite assemblies may comprise one or more of carbon and fiberglass composite materials.

The method may further comprise, after curing, attaching at least two components together using fasteners. The fasteners may be metal or composite clips. The method may further comprise, after curing the joined components, applying one or more additional composite plies over a seam between two components, and curing the additional composite plies to bond the additional composite plies to the single composite assembly.

The method may further comprise wrapping one or more additional composite plies around the single composite assembly, and curing the additional composite plies to bond the additional composite plies to the single composite assembly. The molds for the two or more uncured components may comprise female tools. The molds for the two or more uncured components may comprise both female tools and male tools.

In a further example embodiment, a method of manufacturing composite assemblies comprise laying up composite plies on molds for two or more uncured outer components, laying up composite plies on a mandrel for one or more uncured inner components, joining the molds for the two or more uncured outer components to form a tubular body that surrounds the mandrel, and curing the two or more uncured outer components and the one or more uncured inner components simultaneously to create a single composite assembly.

The method may further comprise forming at least one axial edge having a sloped shape on the uncured outer components, and mating the sloped axial edges together when joining the uncured outer components. The composite plies on the mandrel may form a single uncured inner component that wraps around the circumference of the mandrel. The composite plies on the mandrel may form two or more uncured inner component that each wrap partially around the circumference of the mandrel. The composite plies on the mandrel may form a single uncured inner component that wraps partially around the circumference of the mandrel.

The method may further comprise, after curing the components to create the single composite assembly, applying one or more additional composite plies over a seam between two outer components, and curing the additional composite plies to bond the additional composite plies to the single composite assembly. The method may further comprise wrapping one or more additional composite plies around the single composite assembly, and curing the additional composite plies to bond the additional composite plies to the single composite assembly.

In another example embodiment, a device comprises two or more outer composite assemblies that are separately laid up in different tools and then cured together to form a tubular composite structure. The device may further comprise an inner composite assembly configured to fit between the outer composite assemblies and cured together with the outer assemblies to form the tubular composite structure. The device may further comprise one or more fasteners configured to reinforce an attachment between two outer composite assemblies.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method of manufacturing composite assemblies, comprising:
laying up composite plies on molds for two or more uncured components;
joining the molds for the two or more uncured components to form a tubular body; and
curing the joined components simultaneously to create a single composite assembly.

2. The method of claim 1, further comprising:
forming at least one axial edge having a sloped shape on the uncured components; and
mating the sloped axial edges together when joining the uncured components.

3. The method of claim 1, further comprising:
after curing, attaching at least two components together using fasteners.

4. The method of claim 3, wherein the fasteners are metal or composite clips.

5. The method of claim 1, further comprising:
after curing the joined components, applying one or more additional composite plies over a seam between two components; and
curing the additional composite plies to bond the additional composite plies to the single composite assembly.

6. The method of claim 1, further comprising:
wrapping one or more additional composite plies around the single composite assembly; and
curing the additional composite plies to bond the additional composite plies to the single composite assembly.

7. The method of claim 1, wherein the molds for the two or more uncured components comprise female tools.

8. The method of claim 1, wherein the molds for the two or more uncured components comprise both female tools and male tools.

9. The method of claim 1, wherein the single composite assembly forms a spar for an aerodynamic component.

10. The method of claim 1, wherein the two or more cured composite assemblies comprise one or more of carbon and fiberglass composite materials.

11. A method of manufacturing composite assemblies, comprising:
laying up composite plies on molds for two or more uncured outer components;
laying up composite plies on a mandrel for one or more uncured inner components;
joining the molds for the two or more uncured outer components to form a tubular body that surrounds the mandrel; and
curing the two or more uncured outer components and the one or more uncured inner components simultaneously to create a single composite assembly.

12. The method of claim 11, further comprising:
forming at least one axial edge having a sloped shape on the uncured outer components; and
mating the sloped axial edges together when joining the uncured outer components.

13. The method of claim 11, wherein the composite plies on the mandrel form a single uncured inner component that wraps around the circumference of the mandrel.

14. The method of claim 11, wherein the composite plies on the mandrel form two or more uncured inner component that each wrap partially around the circumference of the mandrel.

15. The method of claim 11, wherein the composite plies on the mandrel form a single uncured inner component that wraps partially around the circumference of the mandrel.

16. The method of claim 11, further comprising:
after curing the components to create the single composite assembly, applying one or more additional composite plies over a seam between two outer components; and
curing the additional composite plies to bond the additional composite plies to the single composite assembly.

17. The method of claim 11, further comprising:
wrapping one or more additional composite plies around the single composite assembly; and
curing the additional composite plies to bond the additional composite plies to the single composite assembly.

18. A device, comprising:
two or more outer composite assemblies that are separately laid up in different tools and then cured together to form a tubular composite structure.

19. The device of claim 18, further comprising:
an inner composite assembly configured to fit between the outer composite assemblies and cured together with the outer assemblies to form the tubular composite structure.

20. The device of claim 18, further comprising:
one or more fasteners configured to reinforce an attachment between two outer composite assemblies.
